(19) United States
(12) Patent Application Publication
(10) Pub. No.: US 2012/0212818 A1
(43) Pub. Date: Aug. 23, 2012

(54) DIFFRACTIVE OPTICAL ELEMENT AND IMAGING APPARATUS USING THE SAME

(75) Inventors: Toshiaki TAKANO, Osaka (JP); Tetsuya SUZUKI, Osaka (JP); Yoshiyuki SHIMIZU, Osaka (JP); Koji FUJII, Osaka (JP)

(73) Assignee: PANASONIC CORPORATION, Osaka (JP)

(21) Appl. No.: 13/400,779

(22) Filed: Feb. 21, 2012

(30) Foreign Application Priority Data
Feb. 22, 2011 (JP) 2011-035668
Feb. 7, 2012 (JP) 2012-024303

(51) Int. Cl. G02B 27/42

(52) U.S. Cl. 359/558

(57) ABSTRACT

A diffractive optical element includes a diffractive surface. Raised portions and recessed portions are alternately arranged on the diffractive surface. The valley bottoms of the recessed portions are formed to have a chamfered shape.

### CROSS-REFERENCE TO RELATED APPLICATION

This application claims priority to Japanese Patent Application No. 2011-035668 filed on Feb. 22, 2011, and Japanese Patent Application No. 2012-024303 filed on Feb. 7, 2012, the disclosures of which including the specifications, the drawings, and the claims are hereby incorporated by reference in their entirety.

### TECHNICAL FIELD

The present disclosure relates to a diffractive optical element having at least one optical surface formed as a diffractive surface and an imaging apparatus including the diffractive optical element.

### BACKGROUND

A diffractive optical element in which at least one of optical surfaces is formed as a diffractive surface has been known. For example, a diffractive optical element of Japanese Patent Publication No. H9-127321 is configured so that several optical members are stacked on each other and a boundary surface between the optical members is formed as a diffractive surface. The diffractive surface is formed by a diffractive grating having a serrated cross-sectional shape. Specifically, the diffractive surface at one of the optical members includes a plurality of raised portions each having a chevron shape, and as a whole has a shape in which raised and recessed portion are alternately repeated. The diffractive surface at the other of the optical members has an inverted shape relative to the shape of the diffractive surface at the one of the optical members.

### SUMMARY

In forming a diffractive optical element having the above-described diffractive surface, a molding technique such as press molding, etc. is used. However, in the conventional refractive optical element, cracks might occur at valley bottoms of the recessed portions. For example, the diffractive optical element is contracted in a cooling step in molding of the diffractive optical element. In this case, since the raised and recessed portions of the diffractive element are engaged with raised and recessed portions of a metal die, the raised portions of the diffractive optical element receive restriction from the metal die. As a result, cracks might occur at the valley bottoms of the recessed portions of the diffractive optical element. Even in other cases, cracks might occur at the valley bottoms of the recessed portions for various reasons.

In view of the foregoing, a technique disclosed therein has been devised to prevent or reduce cracks in a diffractive optical element.

A diffractive optical element disclosed herein is a diffractive optical element including a diffractive surface in which raised portions and recessed portions are alternately arranged on the diffractive surface and valley bottoms of the recessed portions are formed to have a chamfered shape.

Thus, in the diffractive optical element, each of the valley bottoms of the recessed portions is formed not to have an acute shape but a chamfered shape, so that the occurrence of cracks can be prevented or reduced.

### BRIEF DESCRIPTION OF THE DRAWINGS

FIG. 1 is a schematic cross-sectional view of a diffractive optical element according to a first embodiment.

FIG. 2 is a schematic cross-sectional view of a diffractive optical element according to a variation.

FIG. 3 is a schematic cross-sectional view of a diffractive optical element according to another variation.

FIG. 4 is a view schematically illustrating respective steps for producing a diffractive optical element according to the first embodiment. FIG. A illustrates a state in which a glass material is set on a molding die, and FIG. B illustrates a state in which the glass material is pressed by the molding die.

FIG. 5 is a schematic cross-sectional view of a diffractive optical element according to a second embodiment.

FIG. 6 is a view schematically illustrating respective steps for producing a diffractive optical element according to the second embodiment. FIG. A illustrates a state in which a resin material is set on a molding die, FIG. B illustrates a state in which the resin material is pressed by a first optical member and the molding die, and FIG. C illustrates a state in which the diffractive optical element is removed from the molding die.

FIG. 7 is a schematic cross-sectional view of a diffractive optical element according to a third embodiment.

FIG. 8 is a schematic cross-sectional view of an imaging apparatus according to a fourth embodiment.

### DETAILED DESCRIPTION

Example embodiments will be described in detail below with reference to the accompanying drawings.

### First Embodiment

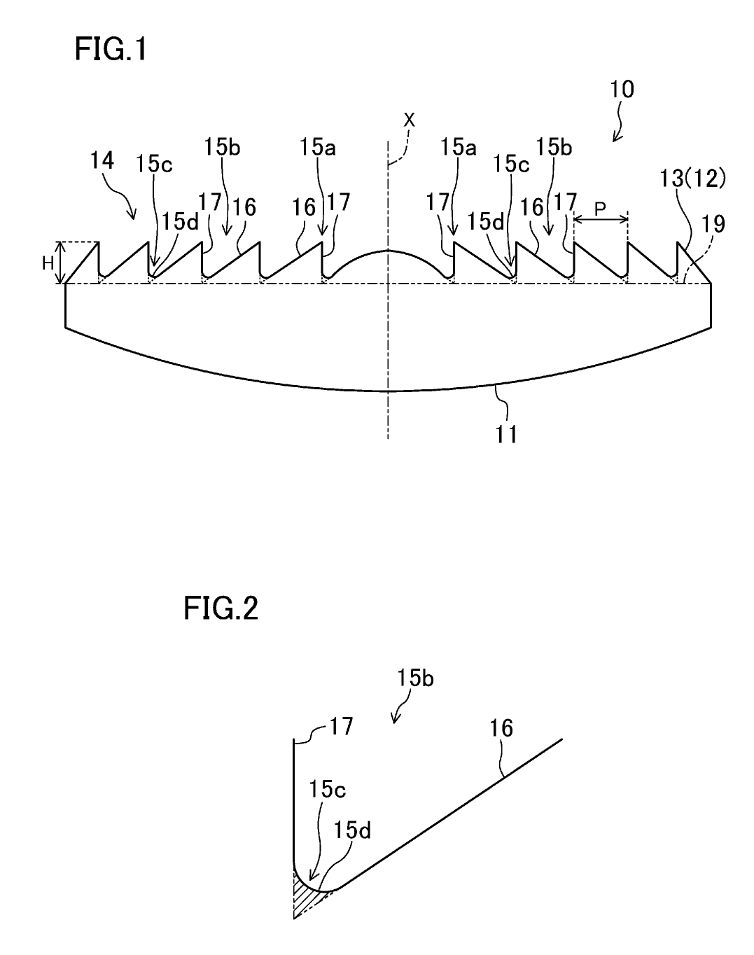

FIG. 1 is a schematic cross-sectional view of a diffractive optical element 10 according to this embodiment.

The diffractive optical element 10 is formed of an optical member which is optically transparent. The diffractive optical element 10 includes a first optical surface 11 and a second optical surface 12 which are opposed to each other. The second optical surface 12 is formed as a diffractive surface 13. That is, at least one optical surface (the second optical surface 12) of the diffractive optical element 10 is formed as the diffractive surface 13. The diffractive optical element 10 may be made of an optical material such as a glass material, or a resin material, etc. Note that the first optical surface 11 may be a spherical or an aspherical surface.

As the diffractive surface 13, a diffractive grating 14 is formed. The diffractive grating 14 includes a plurality of raised portions 15a and a plurality of recessed portions 15b. The raised portions 15a and the recessed portions 15b are formed on a base surface 19. The base surface 19 may be a flat surface. Each of the raised portions 15a extends in a circumferential direction around an optical axis X of the diffractive optical element 10. The plurality of raised portions 15a are regularly arranged in a concentric pattern around the optical axis X. As a result, a recessed portion 15b is formed between adjacent ones of the raised portions 15a. That is, each of the recessed portions 15b extends in the circumferential direction around the optical axis X. The plurality of recessed portions 15b are regularly arranged in a concentric pattern around the optical axis X.

A lateral cross section (a cross section perpendicular to a direction in which the raised portions 15a extend) of each of the raised portions 15a may have a substantially triangular shape. More specifically, each of the raised portions 15a may have a first surface 16 which is tilted relative to the optical axis X and has a diffraction function, and a second surface 17 rising from the base surface 19 and connected to the first surface 16. In each of the raised portions 15a, the first surface 16 is at the outer side in a radial direction around the optical axis X, whereas the second surface 17 is at the inner side in the radiation direction. In adjacent two of the raised portions 15a, the first surface 16 of one of the two raised portions 15a and the second surface 17 of the other of the two raised portions 15a form the recessed portion 15b. That is, it can be also described that the recessed portion 15b has the first surface 16 having the diffraction function and the second surface 17 connected to the first surface 16 and rising from the base surface 19.

In this embodiment, the height (which will be also referred to as “lattice height”) H of the raised portions 15a is substantially uniform throughout the diffractive optical element 10. The height of the raised portions 15a herein means a distance from the base surface 19 to a top (a ridge portion) of each raised portion 15a in the optical axis X direction. The pitch P of the raised portions 15a is smaller in an outer region of the diffractive optical element 10 located outside a central region thereof including the optical axis X than in the central region. Specifically, the pitch P reduces as a distance from the optical axis X in the radial direction increases. The pitch P of the raised portions 15a herein means a distance between adjacent ones of the tops of the raised portions 15a in the radial direction around the optical axis X. For example, the height H of the raised portions 15a is 5-20 μm. The pitch P of the raised portions 15a is 400-2000 μm in the central region A, and is 100-400μ in the outer region. These values can be appropriately set according to optical properties required for the diffractive optical element. Note that the lattice height H of the raised portions 15a can be described as the depth of the recessed portions 15b and the pitch P of the raised portions 15a can be described as the pitch of the recessed portions 15b.

The first surface 16 is a tilted surface which is tilted relative to the optical axis X, and has the diffraction function. A tilt angle of the first surface 16 of each of the raised portions 15a is appropriately set so that the diffractive surface 13 as a whole can have the desired diffraction function.

The second surface 17 extends substantially in parallel to the optical axis X, and is connected to a distal end (a farther end from the base surface 19) of the first surface 16.

A valley bottom 15c of each of the recessed portions 15b has a chamfered shape. The valley bottom 15c herein means a connection portion of the first surface 16 and the second surface 17 forming the recessed portion 15b. The valley bottom 15c corresponds to the lowest portion of the recessed portion 15b. That is, the connection portion of the first surface 16 and the second surface 17 forming the recessed portion 15b is formed by not a valley line but a surface 15d. Specifically, each of the valley bottoms 15c has an R-chamfered (round chamfered) shape, and the radius of curvature is uniform in a cross section of the valley bottom 15c. The chamfered shape of the valley bottoms 15c may be uniform throughout the diffractive surface 13. Note that the term “uniform” in the above phrase “the chamfered shape is uniform” means “substantially uniform,” which includes a fabrication error (for example, an error in shape of the metal die, etc.). In addition, the term “chamfered” means not only formation of a surface in a ridge part but also formation of a surface in a valley part.

With the above-described configuration, cracks of the diffractive grating 14 can be prevented or reduced. If each of the valley bottoms 15c of the recessed portions 15b is formed to have an acute shape with an edge when viewing a lateral cross section (a cross section perpendicular to a direction in which the recessed portions 15b extend) thereof, stress is likely concentrated at the valley bottoms 15c when an external force acts on the raised portions 15a. As a result, cracks might occur at the valley bottoms 15c. As opposed to such a case, concentration of stress in the valley bottoms 15c can be reduced by forming the valley bottoms 15c so that each of the valley bottoms 15c has a chamfered shape. As a result, cracks of the valley bottoms 15c can be prevented or reduced. For example, for a diffractive lens having a diameter of 30 mm or more, the radius of curvature of the lateral cross section of each of the valley bottoms 15c is preferably 2 μm or more, and more preferably 5-10 μm.

Note that, as a variation, as shown in FIG. 2, the chamfered shape of the valley bottoms 15c may be a so-called C-chamfered shape, where the cross-section of the surface 15d is a straight line. In this case, cracks of the valley bottoms 15c can be prevented or reduced. For example, for a diffractive lens having a diameter of 30 mm or more, a width of a surface of each of the valley bottoms 15c (a length of the straight line in the lateral cross section) is preferably 1 μm or more, and more preferably 3-5 μm. Additionally, an angle of a surface formed by chamfering relative to the optical axis X is preferably 30-60 degrees, and more preferably 45 degrees.

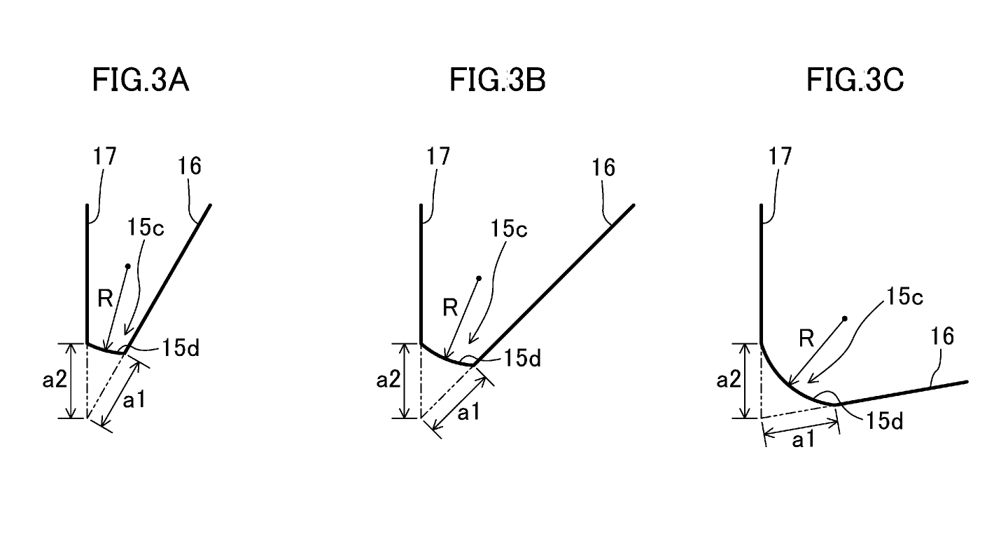

As another variation, as shown in FIG. 3, the chamfered shape of the valley bottoms 15c may be a shape where the cross section of the surface 15d is formed by a straight line and curved lines connected respectively to both ends of the straight line, i.e., a shape formed by a combination of an R-chamfered shape, a C-chamfered shape, and an R-chamfered shape. Even in this case, cracks of the valley bottoms 15c can be prevented or reduced.

[Production Method]

Next, a method for producing a diffractive optical element 10 according to this embodiment will be described.

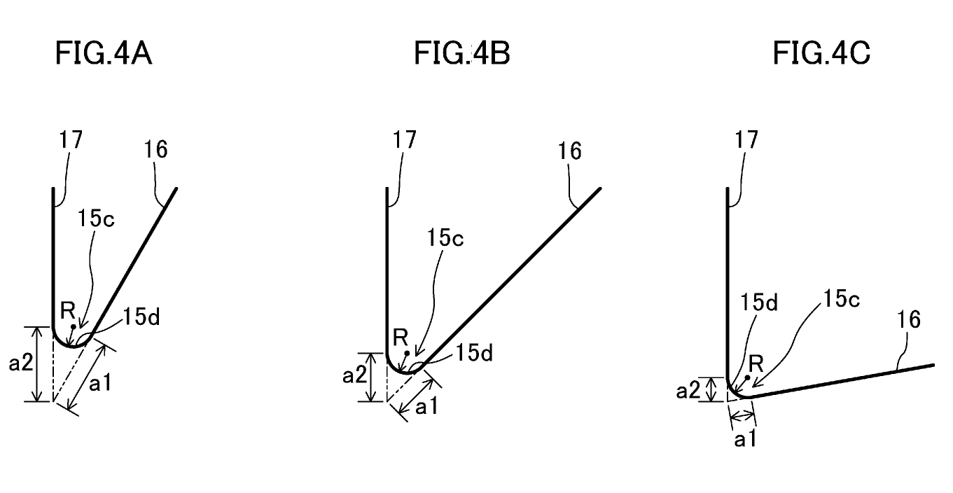

First, as shown in FIG. 4A, a molding die 20 (an upper die 21, a lower die 22, and a body die 23) is prepared. An inverted shape relative to the shape of the diffractive surface 13 is formed in a molding surface of the upper die 21. A molding surface of the lower die 22 is a spherical surface or an aspherical surface. A glass material 30 is placed on the molding surface of the lower die 22. Next, as shown in FIG. 4B, the upper die 21 is moved down toward the lower die 22 along the body die 23, thereby pressing the glass material 30. Process conditions such as a molding temperature and a molding time, etc. are set appropriately.

When the pressing is completed, the upper die 21 is moved upward to remove the glass material 30 from the lower die 22. The glass material 30 is cooled down for a predetermined time, thereby obtaining the diffractive optical element 10.

### Advantages

In the diffractive optical element 10 of this embodiment, the valley bottom 15c of the recessed portion 15b is formed by the first surface 16 and the second surface 17 and has a chamfered shape (i.e., a surface, not a valley line, is formed at the valley bottom 15c), and thus, cracks of the valley bottoms 15c can be prevented or reduced. Specifically, in a cooling step of press molding, the diffractive optical element 10 is contracted. At this time, since the raised portions 15a of the diffractive optical element 10 are engaged with raised portions of the upper die 21, movement of the raised portions 15a in the radial direction is restricted by the raised portions of the upper die 21. Therefore, a force acts on the raised portions 15a outward in the radial direction of the diffractive optical element 10. In this case, stress is likely concentrated at the valley bottoms 15c of the recessed portions 15b, and thus, cracks likely occur at these portions. However, in this embodiment, each of the valley bottoms 15c has a chamfered shape. Concentration of stress in the valley bottoms 15c can be reduced by forming the valley bottoms 15c so that each of the valley bottoms 15c has a chamfered shape. Thus, cracks of the diffractive optical element 10 can be prevented or reduced.

The chamfered shape of the valley bottoms 15c may be uniform throughout the diffractive surface 13. Therefore, cracks of the valley bottoms 15c can be prevented or reduced throughout the entire diffractive surface 13. For example, in the cooling step of press molding, the larger a distance from the center of gravity is, the larger the amount of contraction of the diffractive optical element 10 becomes. Thus, restriction from the upper die 21 is larger at the raised portions 15a located in the outer region of the diffractive optical element 10 in the radial direction than at the raised portions 15a located in the central region of the diffractive optical element 10 in the radial direction. Therefore, cracks more likely occur at the valley bottoms 15c located in the outer region of the diffractive optical element 10 than at the raised portions 15a located in the central region of the diffractive optical element 10. However, cracks of the valley bottoms 15c can occur not only during the cooling step but also when the raised portions 15a hit against some object and receive an external force while being transported, assembled, or used, etc. In such a case, it is not certain at which portion of the diffractive optical element 10 cracks likely occur. Therefore, as described above, by forming the valley bottoms 15c so that the chamfered shape of the valley bottoms 15c is uniform throughout the diffractive surface 13, cracks of the valley bottoms 15c can be uniformly prevented or reduced.

### Second Embodiment

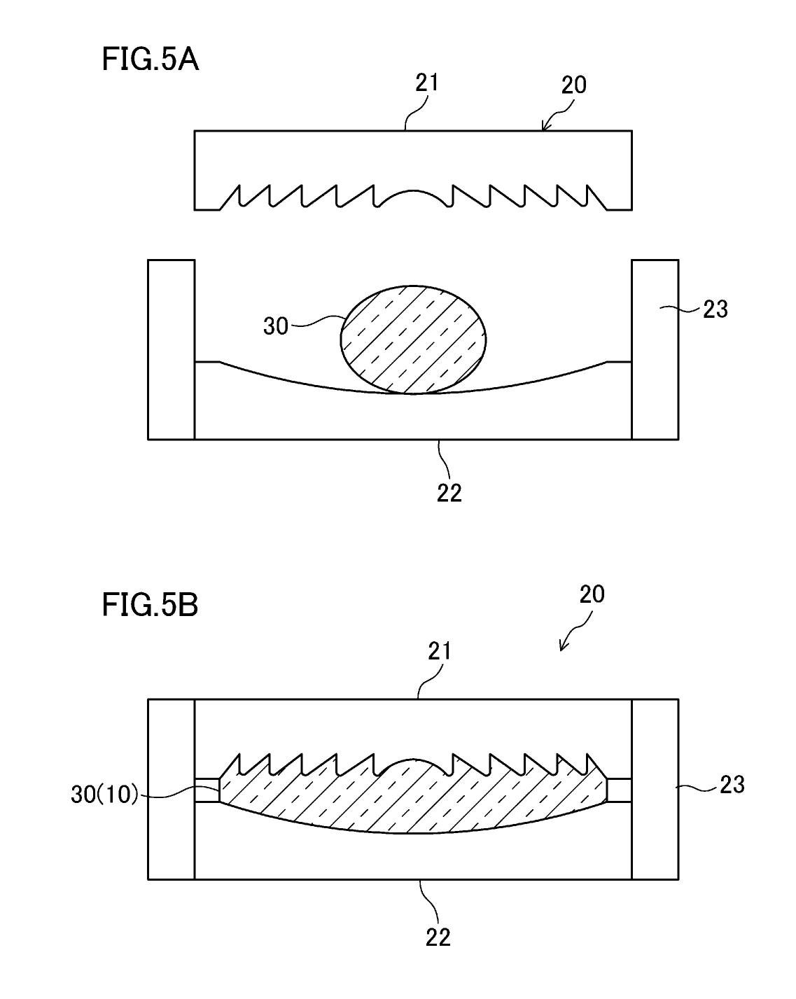

Next, a diffractive optical element 210 according to a second embodiment will be described with reference to the accompanying drawings. FIG. 5 is a schematic cross-sectional view of the diffractive optical element 210.

The diffractive optical element 210 of this embodiment is different from the diffractive optical element 10 of the first embodiment in that a plurality of optical members are stacked on each other. Therefore, the diffractive optical element 210 will be described below with focus on the difference from the diffractive optical element 10 of the first embodiment. Each configuration having similar function and shape to those in the first embodiment is given the same reference characters, and the description thereof might be omitted.

As shown in FIG. 5, the diffractive optical element 210 is a close-contact multilayer diffractive optical element in which a first optical member 231 and a second optical member 232 each of which is optically transparent are stacked on each other.

The first optical member 231 and the second optical member 232 are attached to each other. A boundary surface of the first optical member 231 and the second optical member 232 forms a diffractive surface 13. Since the optical power of the diffractive surface 13 has the dependence on wavelength, the diffractive surface 13 gives substantially the same phase difference to lights having different wavelengths to diffract the lights having different wavelengths at different diffraction angles.

In this embodiment, the first optical member 231 is made of a glass material, and the second optical member 232 is made of a resin material. For example, as the resin material, an ultraviolet curable resin or a thermally curable resin can be used.

[Production Method]

A method for producing the diffractive optical element 210 will be described.

First, the first optical member 231 is prepared. The first optical member 231 can be produced in the same manner as in the first embodiment.

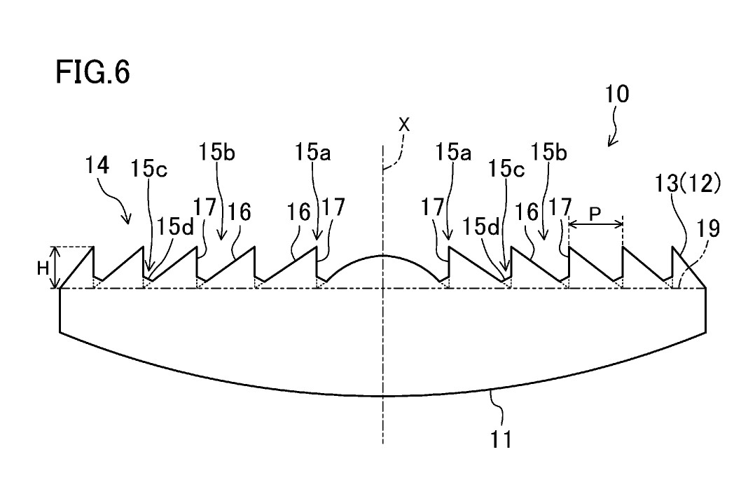

Subsequently, as shown in FIG. 6A, a lower die 224 is prepared. The lower die 224 has a shape corresponding to a shape of a surface of the second optical member 232 which is opposed to the diffractive surface 13. Then, an ultraviolet curable resin material 240 is placed on the lower die 224. Thereafter, the first optical member 231 is moved toward the lower die 224 with the diffractive surface 13 facing toward the lower die 224.

Then, as shown in FIG. 6B, the resin material 240 is pressed by the first optical member 231 and the lower die 224 to deform the resin material 240 into a shape corresponding to the shapes of the first optical member 231 and the lower die 224. Thereafter, the resin material 240 is irradiated with ultraviolet radiation 250. When the resin material 240 has been irradiated with the ultraviolet radiation 250 for a predetermined time, the resin material 240 is hardened, and thus, the second optical member 232 is formed.

Thereafter, as shown in FIG. 6C, the first optical member 231 and the second optical member 232 are removed from the lower die 224, and thus, the diffractive optical element 210 including the first optical member 231 and the second optical member 232 integrated as one can be obtained.

### Third Embodiment

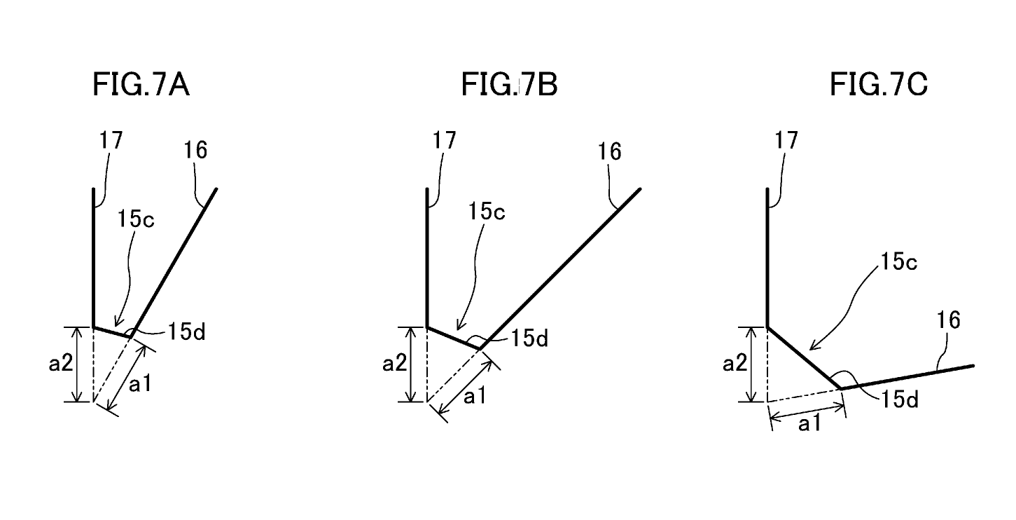

Next, a diffractive optical element 310 according to a third embodiment will be described with reference to the accompanying drawings. FIG. 7 is a schematic cross-sectional view of the diffractive optical element 310.

In the diffractive optical element 310, a third optical member 333 is stacked on the second optical member 232 of the diffractive optical element 210 of the second embodiment. The third optical member 333 may be made of a glass material or a resin material.

### Fourth Embodiment

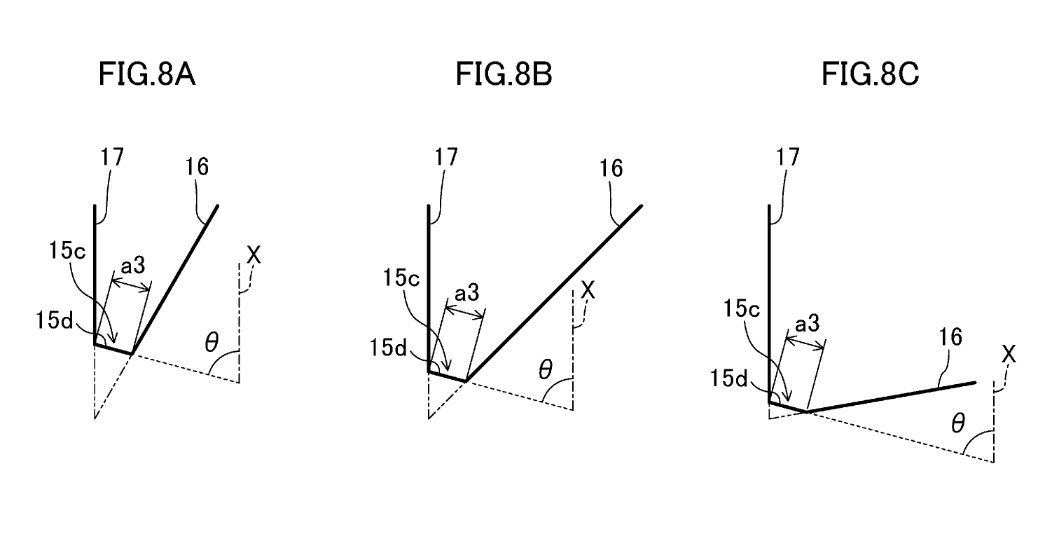

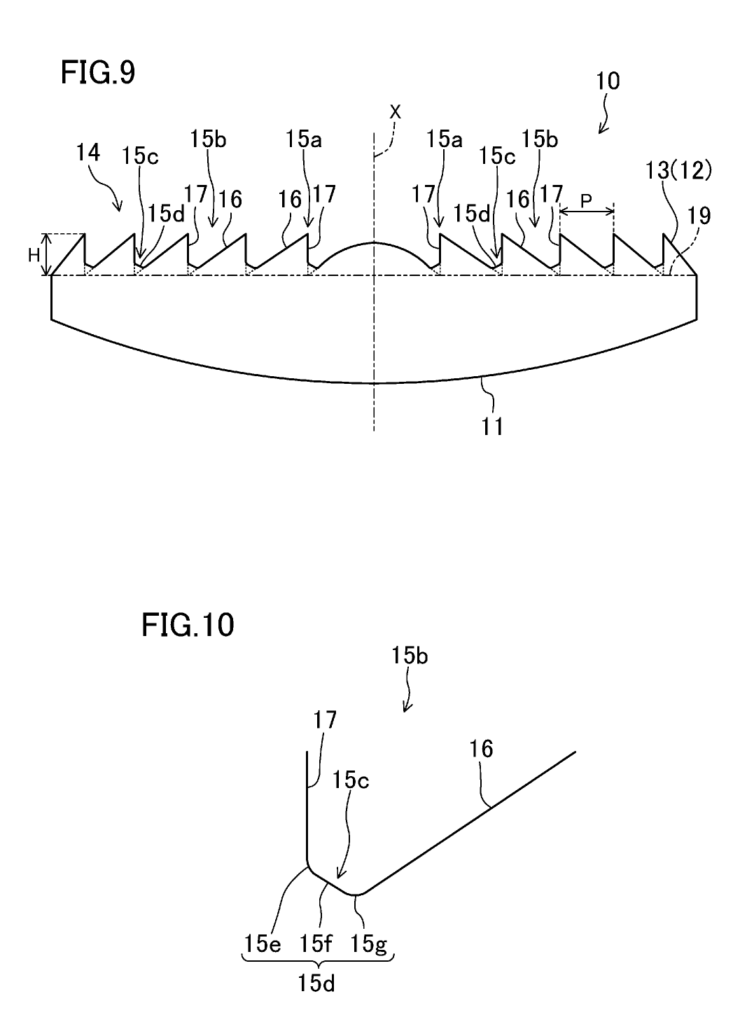

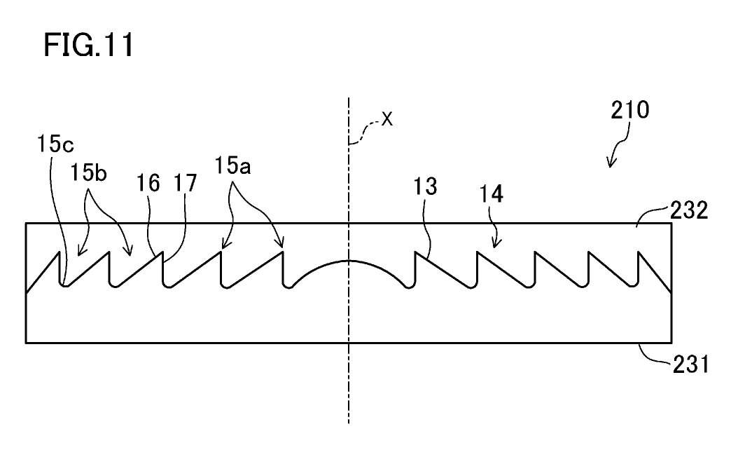

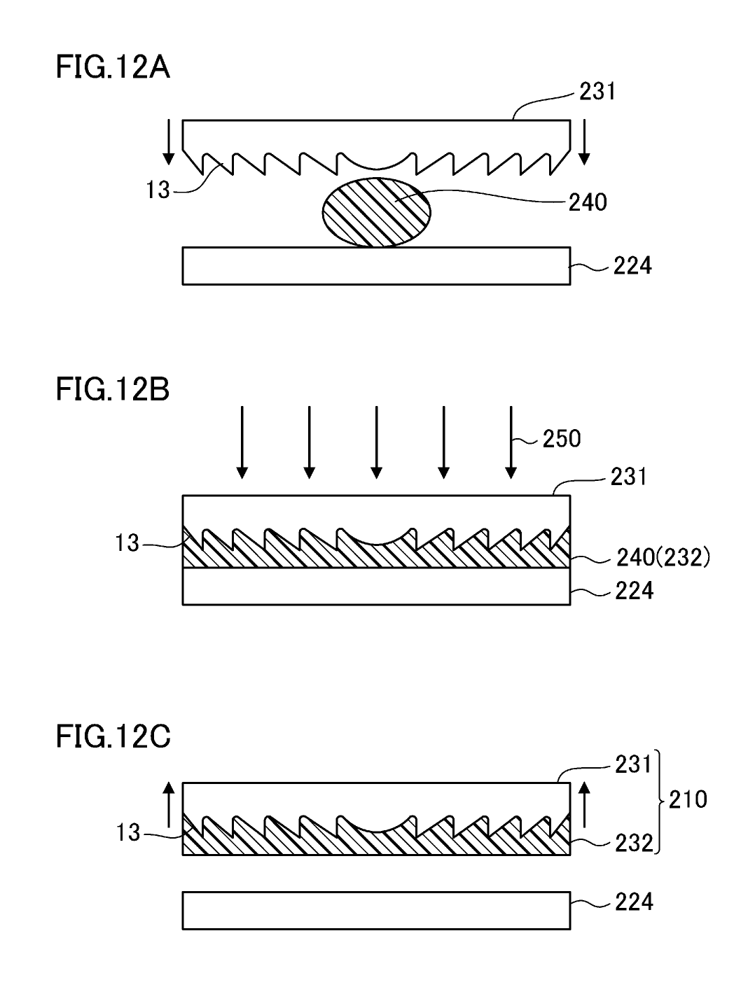

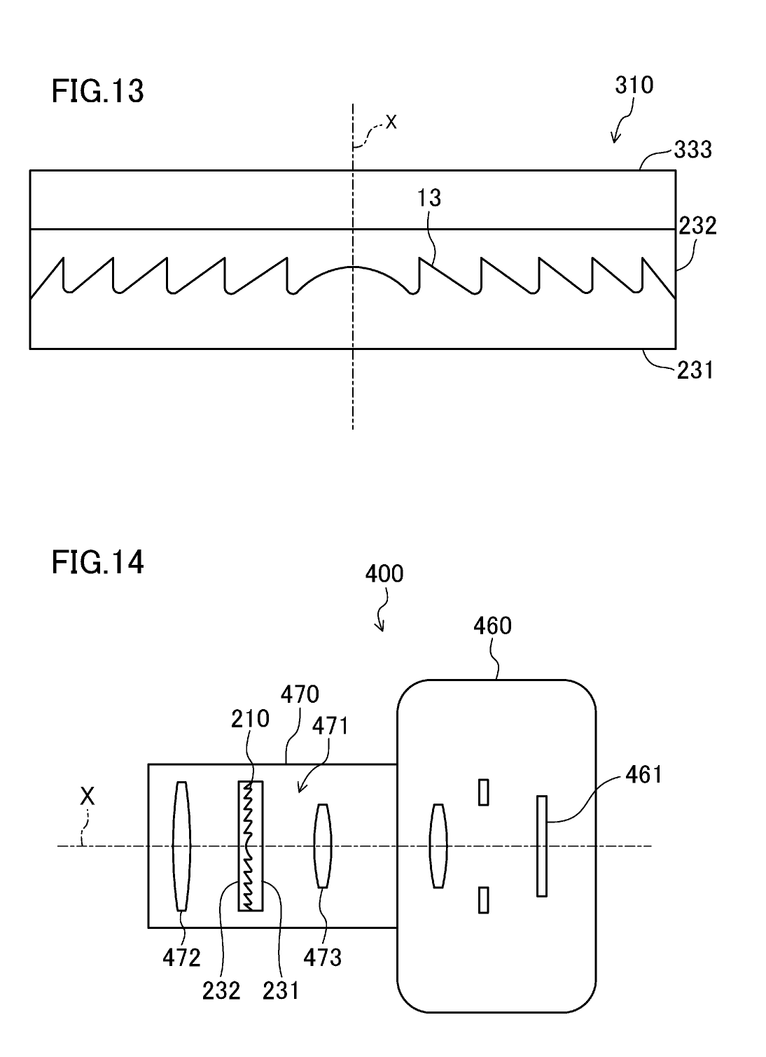

Next, a camera 400 according to a fourth embodiment will be described with reference to the accompanying drawings. FIG. 8 is a schematic view of the camera 400.

The camera 400 includes a camera body 460 and an interchangeable lens 470 coupled to the camera body 460. The camera 400 serves as an imaging apparatus.

The camera body 460 includes an imaging device 461.

The interchangeable lens 470 is configured to be removable from the camera body 460. The interchangeable lens 470 is, for example, a telephoto zoom lens. The interchangeable lens 470 has an imaging optical system 471 for focusing a light bundle on the imaging device 461 of the camera body 460. The imaging optical system 471 includes the diffractive optical element 210 and refracting lenses 472 and 473. The diffractive optical element 210 functions as a lens element. The interchangeable lens 470 serves as an optical apparatus.

### Other Embodiments

The above-described embodiments may have the following configurations.

The configuration of the diffractive grating 14 described in the above-described embodiments is merely one example, and a diffractive grating according to the present disclosure is not limited to the above-described configuration. For example, each of the raised portions 15a is formed so that a surface thereof at the outer side in the radial direction is the first surface 16 and a surface thereof at the inner side in the radial direction is the second surface 17. However, the raised portions 15a are not limited to such a configuration. That is, each of the raised portions 15a may be configured such that a surface thereof at the outer side in the radial direction is the second surface 17, and a surface thereof at the inner side in the radial direction is the first surface 16.

Additionally, the lattice height H and the pitch P of the raised portions 15a are not limited to those described in the above-described embodiments. For example, the lattice height H of the raised portions 15a may be larger in the outer region than in the central region, and alternatively, may be larger in the central region than in the outer region. The pitch P of the raised portions 15a may be smaller in the central region than in the outer region, and alternatively, may be uniform throughout the entire region of the diffractive surface. In the above-described embodiments, the pitch P gradually varies according to a location in the radial direction. However, the diffractive surface may be divided into a plurality of regions, and the pitch P may be set to be uniform in the same region and to be different between different regions. Similarly, the lattice height H may be set in this manner.

In the above-described embodiments, the second surface 17 extends parallel to the optical axis X. However, the second surface 17 is not limited to such a configuration. That is, the second surface 17 may be tilted relative to the optical axis X. In this case, a tilt angle of the second surface 17 relative to the optical axis X may vary according to a location in the diffractive surface 13. For example, the tilt angle of the second surface 17 may be larger in the central region than in the outer region. Alternatively, the second surface 17 may be configured not such that the tilt angle of the second surface 17 gradually varies according to a distance in the radial direction or the height of the raised portions 15a, but such that the diffractive surface 13 may be divided into a plurality of regions based on the distance in the radial direction and the height of the raised portions 15a and the tilt angle of the second surface 17 may be uniform in the same region and different between different regions.

In the above-described embodiments, the chamfered shape of the valley bottoms 15c may be uniform through out the diffractive surface 13. However, the chamfered shape of the valley bottoms 15c is not limited to such a configuration. The chamfered shape of the valley bottoms 15c may vary according to locations in the diffractive surface 13 based on how likely cracks occur and how easily the diffractive surface 13 can be formed therein, etc. Additionally, chamfering may be performed to only some of the valley bottoms 15c in the diffractive surface 13, so that each of the others of the valley bottoms 15c is formed as a valley line.

Furthermore, each of the raised portions 15a has a triangular lateral cross-sectional shape, but is not limited thereto. In the lateral cross-section, the first surface 16 and the second surface 17 are represented by straight lines, but they may have a shape formed by curved lines.

The raised portions 15a may be formed to have a rectangular lateral cross-sectional shape or a step like cross-sectional shape. In such a case, each of the raised portions 15a may have a surface extending substantially perpendicular to the optical axis X and surfaces each rising from the base surface substantially in the optical axis X direction. Each of the former surfaces serves as the first surface 16 having the diffractive function, and each of the latter surfaces serves as the second surface 17 rising from the base surface. In keeping with this example, the bottom of each of the recessed portions 15b is formed by a surface (which will be hereinafter referred to as a “bottom surface”) extending substantially perpendicular to the optical axis X. The second surfaces 17 are connected respectively to both ends of the bottom surface, and each connection portion is normally a valley line. In such a configuration, the connection portion of the bottom surface and each of the second surfaces 17, which is normally formed as a valley line, corresponds to the valley bottom 15c of the recessed portion 15b. The valley bottom 15c formed by the connection portion of the bottom surface of each of the second surfaces 17 is formed to have the chamfered shape.

Additionally, the base surface 19 on which the raised portions 15a are formed is a flat surface, but is not limited thereto. For example, the base surface 19 may be curved to be raised or depressed.

The present disclosure is not limited to the above embodiments, and may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes and modifications which come within the meaning and range of equivalency of the claims are to be embraced within their scope.

The present disclosure is useful for a diffractive optical element including a diffractive surface and an imaging apparatus including the diffractive optical element.

What is claimed is:

1. A diffractive optical element, comprising
a diffractive surface,
wherein
raised portions and recessed portions are alternately arranged on the diffractive surface, and
valley bottoms of the recessed portions are formed to have a chamfered shape.

2. The diffractive optical element of claim 1, wherein
the chamfered shape is uniform throughout the diffractive surface.

3. An imaging device, comprising:
the diffractive optical element of claim 1.
